(19) United States
(12) Patent Application Publication
(10) Pub. No.: US 2011/0171620 A1
(43) Pub. Date: Jul. 14, 2011

(54) SYSTEM AND METHOD FOR AUDIO/VIDEO INTERACTION

(75) Inventors: Shi-Chuan Tzeng, Taipei (TW); Hung-Ju Lin, Taipei (TW)

(73) Assignee: CHUNGHWA TELECOM CO., LTD., Taipei (TW)

(21) Appl. No.: 12/762,101

(22) Filed: Apr. 16, 2010

(30) Foreign Application Priority Data
Jan. 8, 2010 (TW) 099100328

(51) Int. Cl. G09B 5/00

(52) U.S. Cl. 434/309

(57) ABSTRACT

An audio/video interaction method whereby users interact with an output audio/video file is provided. The method includes obtaining input behaviors performed by a user on an audio/video file to serve as behavior information and storing the same in a behavior database thereof; and comparing predetermined behavior patterns in a database with the user's behavior information to obtain a feedback information and further analyzing the behavior information to generate corresponding statistical data, thereby providing feedback information upon the output of the audio/video file or providing the statistical data when the output thereof is discontinued.

### BACKGROUND OF THE INVENTION

1. Field of the Invention

This invention relates to systems and methods for audio/video interaction, and more particularly, to an audio/video system with which a user interacts with an audio/video signal when the audio/video system outputs the audio/video signal and which performs information feedback and statistical analysis on the user's input behaviors, and a related audio/video interaction method.

2. Description of Related Art

Owing to the rapid development and wide use of network application, people nowadays cannot undertake daily routines, learning (e.g., on-line learning), and entertainment (e.g., on-line film viewing) without the Internet. Accordingly, network service providers provide various network services, such as Web-based teaching or on-line amusement.

However, existing network service providers offer Web-based teaching and on-line amusement mostly in a one-way manner or by text-based interaction, and thus audio/video films posted on a Website can only be watched online, thereby leaving little room for content-user interaction services. For example, a learner watches an on-line teaching film but cannot interact with the film. Accordingly, the learner cannot take notes in time while watching the film; instead, the learner can take notes only after pausing the film. In general, entertainment films entertain an audience's eyes only. Existing interactive films allow viewers to perform no more than a simple operation by pressing graphic buttons beside the screen, but the viewers are not allowed to perform interactive operations on the films being played. To with, viewers watching a film are not allowed to select a specific frame for storage purposes by the viewers' interaction behaviors, such as clicking or circling contents within a part of the film. The viewers are not allowed to obtain useful information by a film interaction process, such as popular segment record, picture-capturing or film feedback effects, and the segments that most viewers are interested in cannot generate feedback messages through statistical analysis. Therefore, the film being played is too monotonous to be interesting. Accordingly, there is still room for improvement on the prior art.

Hence, it is imperative to enable a film being played to provide users with more interaction by interaction behaviors, such as clicking feedback and partial content circling, such that the film watching is no longer limit to mere viewing and performing interaction functions through the graphic buttons installed beside the film playing window as disclosed in the prior art, and provide a real-time feedback, statistical information or the reapplication of the film contents during an interaction process to thereby allow the users to have more applications on the film playing process.

### SUMMARY OF THE INVENTION

In view of the above-mentioned problems of the prior art, the present invention provides an audio/video interaction system and an audio/video interaction method thereof, allowing a user viewing a film to perform interaction behaviors directly, thereby generating corresponding feedback information and analyzing and gathering statistics of the usage behaviors of the user.

The audio/video interaction system includes a capturing module for capturing a user's input behaviors performed on an audio/video file being played, and taking the captured input behaviors as behavior information; a behavior database for storing predetermined behavior patterns and the behavior information captured by the capturing module; a behavior analyzing module for analyzing the behavior information, and generating and storing statistical information; and an interaction module that compares the behavior information and the predetermined behavior patterns, and providing corresponding feedback information.

In an embodiment, the behavior information comprises selection information, circle information, click information and picture-capturing information generated by the user through the input behaviors by selecting, circling, clicking or frame-capturing.

In another embodiment, a playing module is further included for playing the audio/video file, wherein the capturing module captures usage behaviors of the user on the playing module.

In yet another embodiment, a compiling module is further included for compiling pictures, allowing the user to compile the captured pictures.

The audio/video interaction method includes the steps of: (1) capturing input behaviors of a user when an audio/video file is output, and taking the input behaviors as behavior information; and (2) comparing the behavior information with predetermined behavior patterns to obtain corresponding feedback information, and analyzing the behavior information to generate corresponding statistical data, thereby providing the feedback information when the audio/video file is output or providing the statistical data when the outputting of the audio/video file is discontinued.

Compared with the prior art, the audio/video interaction system and audio/video interaction method thereof of the present invention allow a user to interact with a film, by performing circling, click or picture-capturing actions on the film while the film is being played, so as to generate corresponding feedback information and statistical data, such as direct message response after the film interaction or analyzing the behavior patterns of the user. Accordingly, the appropriate messages may be provided a while after the film has started to play, and additional applications on the film playing process may be provided. Moreover, the present invention compiles the captured pictures through a compiling unit. In particular, in a teaching film the captured film contents may be compiled and converted into notes, providing the user a more simplified learning process. The audio/video interaction system and the method thereof may be applied to an on-line platform, allowing an on-line film not only to be viewed by the user, but also provide more learning applications and amusement effects through direct interaction.

### BRIEF DESCRIPTION OF DRAWINGS

FIG. 1 is a functional block diagram of an audio/video interaction system of a first embodiment according to the present invention;

FIG. 2 is a functional block diagram of an audio/video interaction system of a second embodiment according to the present invention;

FIG. 3 illustrates an audio/video frame provided through the application of an audio/video interaction system of the present invention;

FIG. 4A is a flow chart illustrating that a user captures frames of a film being played, by using an audio/video interaction system of the present invention;

FIG. 4B is a flow chart illustrating that a user circles coordinates of a film being played, by using an audio/video interaction system of the present invention;

FIG. 5 is a functional block diagram of an audio/video interaction system of a third embodiment according to the present invention; and

FIG. 6 is a flow chart of an audio/video interaction method according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be implemented or applied by other different embodiments. The details of the specification may be on the basis of different points and applications, and numerous modifications and variations can be devised without departing from the spirit of the present invention.

Referring to FIG. 1, there is shown a functional block diagram of an audio/video interaction system 1 of a first embodiment according to the present invention. A user is allowed to use the audio/video interaction system 1 to browse and interact with the playing audio/video frames and analyze input behaviors. As shown in the functional block diagram, the audio/video interaction system 1 comprises a capturing module 11, a behavior database 12, a behavior analyzing module 13 and an interaction module 14. The capturing module 11 captures input behaviors 100 of a user on an audio/video file being played and takes them as behavior information. When the user is viewing a film, the capturing module 11 captures gesture behaviors, such as selecting, circling, clicking or frame-capturing, performed by the user before a film playing window, and stores the captured information into the behavior database 12.

The behavior database 12 is for storing predetermined behavior patterns and the behavior information captured by the capturing module 11. The predetermined behavior patterns refer to possible behavior patterns between the user and the film, such that the user may get corresponding feedback when the behaviors appear. In the first embodiment, the behavior information includes user data, film data and time data. The behavior information may further include the aforesaid input behaviors 100, such as captured frames and selected areas, and corresponding information generated by the input behaviors 100. In practice, the audio/video interaction system 1 may record the segments of the film that the user has viewed, specific behaviors performed by the user at a specific time point, and corresponding data generated by the user. The aforesaid information constitutes the behavior information, which may be used by the behavior analyzing module 13 or the interaction module 14 subsequently.

The behavior analyzing module 13 analyzes the behavior information and generates statistical information 200. To be specific, the behavior analyzing module 13 gathers statistics of the behavior information, analyzes the behavior information, and generates the statistical information 200 relating to various behaviors of all the users. Through the use of the statistical information 200, the behaviors performed by the majority of the users when viewing the film may be identified. For example, if some segments of a film are fast forwarded all the time, the behavior analyzing module 13 will infer that those segments are unattractive. A segment from a specific time point may be regarded as an important part of the film, if the users always start to view the film from the time point. Accordingly, given the statistical information 200, the contents of the film can be adjusted, or corresponding instructions can be given to subsequent users. Alternatively, the behavior analyzing module 13 may analyze the behavior information obtained from the behavior database 12, and then store the analyzed behavior information back into the behavior database 12. In particular, in a circumstance where the behavior analyzing module 13 cannot determine behavior information unless the amount of the behavior information is greater than a predetermined threshold, the behavior analyzing module 13, after analyzing each piece of the behavior information, stores the analyzed behavior information into the behavior database 12, or into a storage unit (not shown) that is designed to store the analyzed information, and generates the statistical information 200 thus finalized after the amount of the analyzed information is greater than the predetermined threshold or a predetermined time period has elapsed.

The interaction module 14 compares the behavior information with the predetermined behavior patterns, and provides corresponding feedback information 300. The feedback information 300 includes the displaying information fed back to a user in real time, and corresponding information generated when the audio/video interaction ends. In addition to analyzing the users' interaction behaviors by the behavior analyzing module 13, the audio/video interaction system 1 further provides the feedback information 300 in real time or at the end of the film. To be specific, when a user uses a mouse to select a specific role in a film, the corresponding information relating to the role will be provided in real time. Alternatively, when a user selects some segments of a film while playing the film, the selected segments may be stored first, and then corresponding information may be provided to the user, especially for the Q-and-A interactive film.

The interaction module 14 provides corresponding displaying information according to the statistical information 200 while the audio/video file is playing. The contents of the statistical information 200 generated by the behavior analyzing module 13 after analysis, such as popular segments, unpopular segments, and important segments, may be integrated with the time point of the original film, and serve as the displaying information that prompts corresponding messages while the subsequent viewers are viewing the film.

The input behaviors 100 refer to behavior information, such as selection information, circle information, click information or picture-capturing information, generated by the user through the user's interaction behaviors, such as selection, circling, clicking or capturing pictures. In other words, the present invention is aimed at the behaviors performed by a user directly to a film while the film is playing, while the prior art allows the user to make gestures by pressing the picture buttons located beside the screen on which the film is playing. Therefore, the present invention allows a user to interact with the film directly, making the interactive process more direct and efficient, as compared with the prior art.

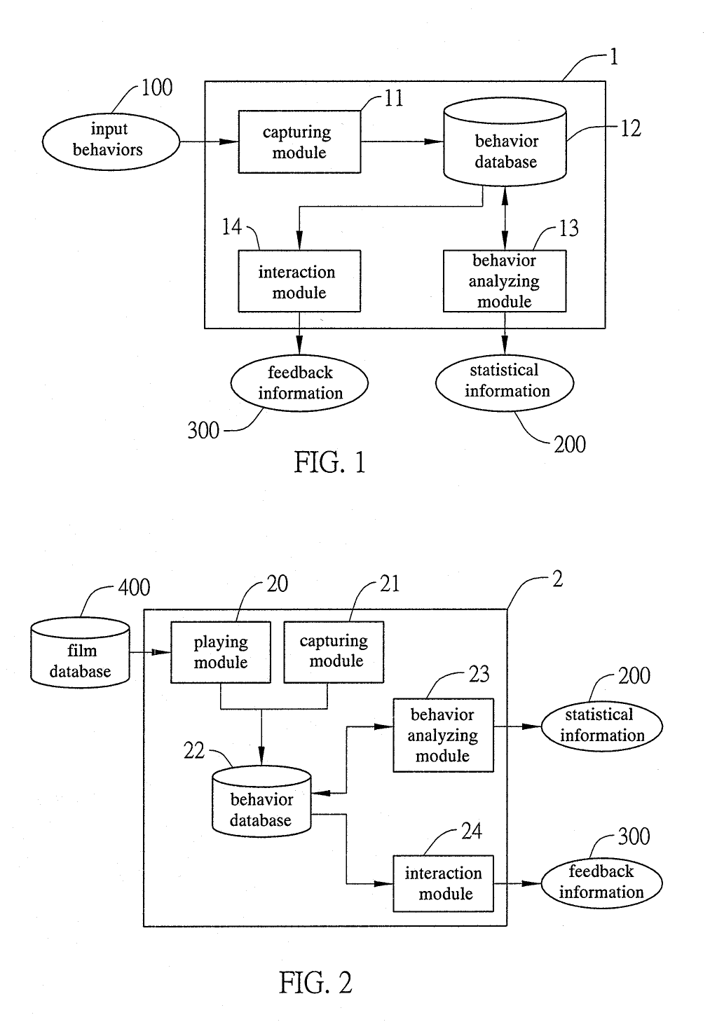

Referring to FIG. 2, there is shown a functional block diagram of an audio/video interaction system 2 of a second embodiment according to the present invention. As shown in the functional block diagram, the audio/video interaction system 2 differs from the audio/video interaction system 1 of the first embodiment in that the audio/video interaction system 2 further comprises a playing module 20 for playing the audio/video file, and that the capturing module 21 captures input behaviors performed by a user on the playing module 20.

The playing module 20 plays films available in a film database 400. As described previously, since the present invention allows a user to interact with a film directly, the playing module 20 operates in conjunction with the capturing module 21. In particular, the capturing module 21 may interact with the film playing window directly. In practice, the capturing module 21 captures input coordinates or picture information of the audio/video file when the user performs input behaviors, as one of the parameters included in corresponding behavior information generated. In order to identify the interaction behaviors performed by the user on the film, the present invention uses coordinate records to obtain the interactive position of a mouse manipulated by the user on the film. Moreover, an audio/video interaction system of the present invention is not limited to a single unit only, but may also be applied to an on-line service platform. In order to prevent the occurrence of coordinate variance due to variant-sized Webpage windows presented as a result of downloading information from a network, the audio/video Webpage window preferably has a constant size, such that the correctness of the coordinate locations obtained through the location relation are ensured.

The behavior information captured by the capturing module 21 in the playing windows of the playing module 20 is stored in the behavior database 22, and input time when the behaviors are input, input coordinates, gesture behaviors indicated by the input behaviors, and generated results are obtained simultaneously. Accordingly, the behavior analyzing module 23 may analyze and generate the statistical information 200, or the behavior module 23 may store analysis results generated by analyzing the each behavior information back into the behavior database 22 and, after the amount of the behavior information is greater than the predetermined threshold, generate corresponding statistical information 200 and provide the behavior information to the interaction module 24, which determines the behavior information and generates the feedback information 300.

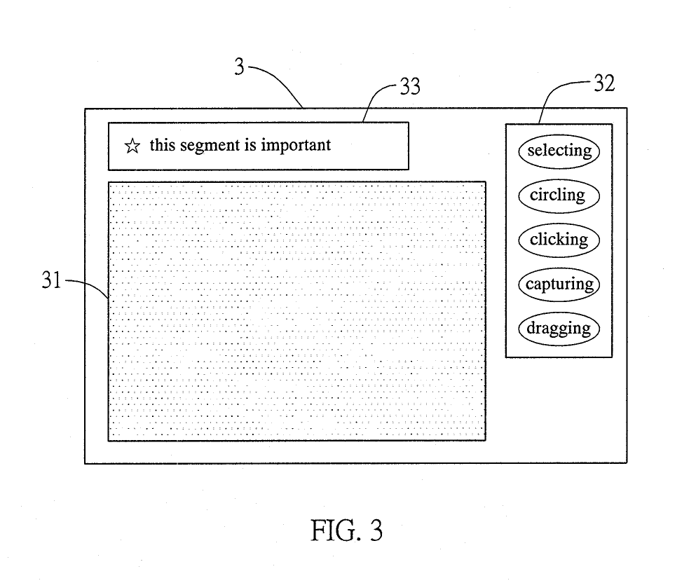

Referring to FIG. 3, there is shown an audio/video frame 3 provided through the application of an audio/video interaction system of the present invention. In order to ensure the correctness of the coordinates of an area where a user's interaction behaviors are captured, the audio/video frame 3 has a constant size. As shown in the drawing, the audio/video frame 3 includes a film displaying area 31, a behavior tool area 32, and an information displaying area 33. The film displaying area 31 is a film playing window, and is also an area where a user may interact with a film. Accordingly, the user may select, circle, click, capture pictures, or drag within the film displaying area 31. The behavior tool area 32 provides tools to the user, such that the user may interact with a film being played with the film displaying area 31. When the user wants to interact with a film being played within the film displaying area 31, the user may select behavior tools, such as selecting, circling, clicking, capturing or dragging, provided by the behavior tool area 32, and input on the film displaying area 31 based on the selected behavior tools. The inputting behavior is the behavior tool selected on the behavior tool area 32. Therefore, the behavior analyzing module 23 identifies the interaction behavior between the user and the film being played. The information displaying area 33 is used for displaying real-time feedback information of an interactive process, or combining the great amount of input behaviors that have been analyzed previously with the playing of a film and giving the user displaying information for indication during subsequent a playing process.

The aforesaid behaviors, such as the selecting, circling, clicking, picture-capturing or dragging, refer to interaction behaviors that the user performs on the file film being played within the film displaying area 31. The behaviors may include selecting a specific selection item, circling a specific range, clicking on a specific position, capturing a picture directly or dragging corresponding objects. In an embodiment of dragging an object, when a film is playing, the user may drag objects (not shown, a dedicated area may be installed additionally) that are not within the film displaying area 31 into the playing film frame, thereby obtaining the information related to the user, such as interaction behavior time, dragging object content and drag coordinate location, determining the interaction behaviors, and giving corresponding feedback information.

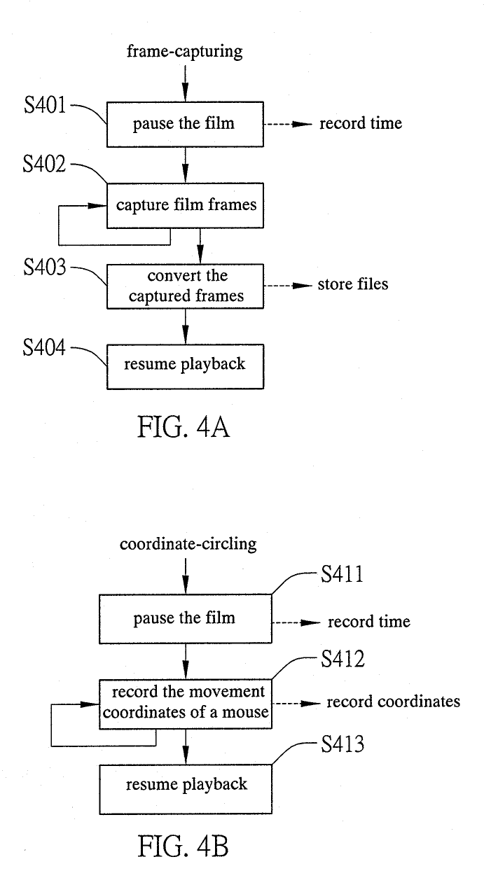

Referring to FIG. 4A, there is shown a flow chart illustrating that a user captures frames of a film being played, by using an audio/video interaction system of the present invention. As shown in the flow chart, when the interaction behavior of the user is “picturing-capturing”, proceed to step S401 first. In step S401, the capturing module informs the playing module to pause the playing of the film and to record the current playing time of the film simultaneously. Proceed to step S402, in which the capturing module captures a frame in part or in whole. Alternatively, in step S402, partial picture capturing may be performed in a plurality of instances, or, in other words, many portions of the same film frame may be selected. Proceed to step S403, in which the content of the captured frame has its format converted into an image format, and is stored, for subsequent access and view. Proceed to step S404, in which the playing of the film resumes as soon as the interaction behaviors of the user are done.

Referring to FIG. 4B, there is shown a flow chart illustrating that a user circles a coordinate of a film being played by using an audio/video interaction system of the present invention. As shown in the flow chart, when the interaction behavior of a user is “coordinate circling”, proceed to step S411 first. In step S411, the capturing module informs the playing module to pause the playing of the film, and to record the current playing time of the film simultaneously. Proceed to step S412, in which the capturing module captures the coordinates of an area where a mouse clicks, to identify the coordinate position of an area selected by the user, thereby determining the relationship of the user's behaviors and predetermined behavior patterns. Likewise, a plurality of instances of coordinate capturing may be performed, to capture the same frame many times. The captured frame is then recorded and stored. Proceed to step S413, in which the playing of the film resumes as soon as the interaction behaviors of the user are done.

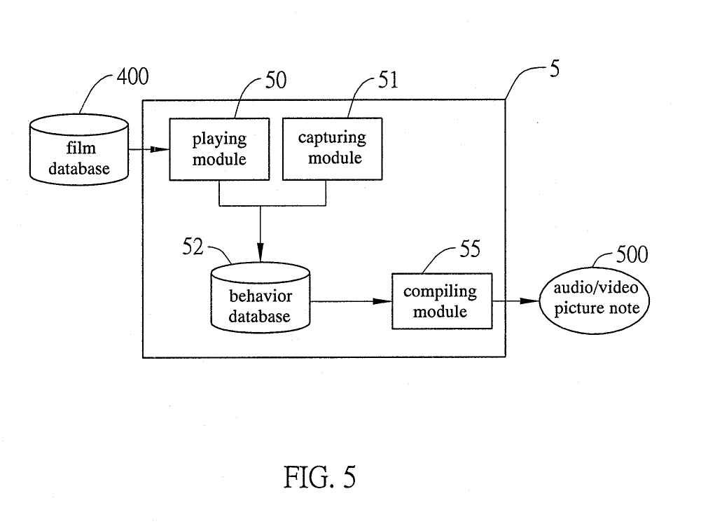

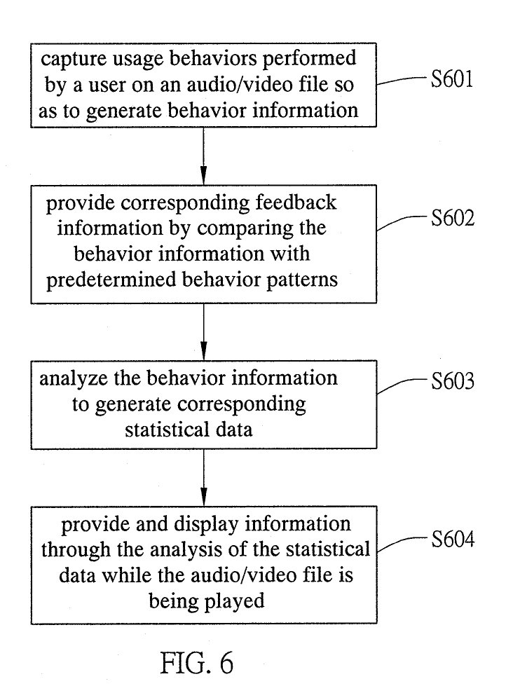

Referring to FIG. 5, there is shown a functional block diagram of an audio/video interaction system 5 of a third embodiment according to the present invention. As shown in the functional block diagram, the audio/video interaction system 5 differs from the audio/video interaction system 2 shown in FIG. 2 in that the audio/video interaction system 5 further comprises a compiling module 55 for compiling pictures, thereby allowing a user to compile captured pictures. The compiling module 55 compiles the captured image pictures to enhance usefulness thereof. The capturing module 51 captures image pictures of a film (especially a text-based teaching film) being played by the playing module 50, and stores the image pictures in the behavior database 52, thereby allowing a user to compile the pictures with the compiling module 55 so as to generate an audio/video picture note 500. Accordingly, the audio/video interaction system of the present invention enables a user to take notes in a time-efficient manner while watching a film.

The audio/video interaction system of the present invention has a great variety of applications. In practice, frame capturing allows an interactive Q-and-A session to take place while a film is playing. For example, the true sign “O”, the false sign “X”, or a numeral that appears in a film is circled by a user using a mouse and then compared with captured images by reference to the film time so as to give feedback in real time or provide statistics of answers at the end of the film. Additionally, specific images, characters or objects may be circled, so as to provide corresponding prompting messages or perform comparison to determine whether the answers circled are correct, such as the introduction of film characters or a game that finds the differences between two pictures.

In another practical example, a position where a user clicks while a film is being played may be determined through a coordinate circling. In practice, adding questions and corresponding selection items at different time points in a film allows the system to record, after a user has clicked the selection items with a mouse, a coordinate where the user is clicking and the film time, for determining whether items selected by the user are correct or conducting subsequent statistics of the correctly selected items.

In yet another practical example, pictures generated through frame capturing may be complied. In the prior art, a user usually have difficulty in taking notes while viewing a teaching film. In the present invention, the user is allowed to capture the film frame directly, and the captured pictures may be rendered usable by picture compilation, such as converting a film picture that shows a black background with white text (as is the case where words are written on a blackboard with chalk) into one that shows a white background with black text, allowing a user to read or print the film picture readily, or even put lines in the film picture or annotate the film picture; hence, the user can take notes easily and efficiently during a learning process.

In still another practical example, no feedback information can be generated in real time in response to a user's interaction behaviors. A user viewing a film may take various actions, such as pausing, forwarding, or even jumping to the next segment or the next playing time point. Accordingly, the system may record and analyze these interaction behaviors only. In other words, these interaction behaviors will not be immediately followed by the generation of feedback information unless and until the system collects enough information related to interaction behaviors performed by a plurality of users during the film playing process. For example, where a film is played to an audience hundreds or thousands strong, the majority of the audience may perform specific interaction behaviors at the same playing time point, such as forwarding or jumping to the next segment. At last, the system will not generate corresponding feedback information and provide the corresponding feedback information to users who view the film subsequently until the system has gathered the statistics of these interaction behaviors. For example, a message, which says that the majority of the audience of a film are likely to forward or jump to the next segment of the film being played at a specific playing time point, is displayed on the film being played at the specific playing time point, so as to provide the subsequent users with useful information.

Moreover, the circling behavior may be performed on a film picture at a plurality of positions thereof, in a plurality of instances, and at the same film playing time point, as in the situation where a user circles a plurality of answers, disperses main features of a frame, or repeatedly circles the same area (e.g., capturing a human portrait image first, and then capturing a human face image). The present invention provides analysis and storage in different scenarios. Moreover, application of an audio/video interaction system of the present invention is not limited to a single audio/video device; instead, the system of the present invention may also be applied to an on-line service platform. Accordingly, the system of the present invention can record and analyze the film usage condition, so as to identify the behaviors performed by most of the users while watching the film, and find out the special features of the film, such as taking an often-forwarded area as indicative of unimportance, or marking the starting time point of a must-watch segment of the film to indicate the shortcut of the approach to the theme of the film, which allows the users to view the film in a time-efficient manner.

Referring to FIG. 6, there is shown a flow chart of an audio/video interaction method according to the present invention. As shown in the flow chart, the audio/video interaction method of the present invention is applied when a user is performing audio/video interaction and the analysis of input behaviors, and includes steps S601 to S604.

In step S601, a user's input behaviors performed on an audio/video file are captured and treated as behavior information. In practice, interaction behaviors performed by the user on a film being played are captured for use in subsequent feedback and analysis. The behavior information comprises corresponding selection information, circle information, click information or picture-capturing information generated by the user when selecting, circling, clicking or frame-capturing, and user data, film data and time data of the interaction behaviors. Proceed to step S601.

Additionally, step S601 further comprises capturing a coordinate location of the input behaviors performed by the user on the audio/video file or the captured pictures of the audio/video file, followed by taking the captured coordinate location or the captured pictures of the audio/video file as a parameter for generating the behavior information. Simply speaking, when a user performs interaction behavior on a film being played, film pictures may be captured through a mouse on the corresponding coordinates of the film displaying window or by the user directly, thereby knowing the user's clicking or circling position in the film displaying window.

In step S602, the behavior information and predetermined behavior patterns are compared, to provide corresponding feedback information. The feedback information comprises display information fed back to the user in real time and corresponding information given to the user when the audio/video interaction ends. If the behavior information is determined to be fed back immediately, the feedback information are provided to the user in real time, or the corresponding feedback information are buffered and then provided to the user after the playing of the film ends. Proceed to step S603.

Additionally, step S602 further comprises performing picture post-producing and compiling on the captured pictures. In other words, the captured pictures, when post-produced and compiled, may be stored or used by the user. Step S602 is especially important to a teaching film, by converting the text on a blackboard into notes, so as to avoid the hassle of taking notes while viewing the film.

In step S603, the behavior information is analyzed to generate corresponding statistical data. In other words, the statistical analysis of the user behaviors may be generated through the behavior information. Accordingly, the habits of the user may be understood, and a manager may adjust and use the film subsequently. Proceed to step S604.

In step S604, given the analysis of the statistical data, information is provided and displayed while the audio/video film is playing, or, in other words, adding prompting or film adjustment to the statistical data generated in step S603 while the film is playing, thereby allowing the film to meet user needs.

In sum, the present invention provides an audio/video interaction system and an audio/video interaction method thereof. Compared to the prior art, the present invention allows a user to interact directly with a film being played, such as circling, clicking or picture-capturing the film, thereby generating corresponding feedback messages or statistical data. For example, the film interaction system may perform a variety of interaction on amusement film clicking interaction or Q-and-A in a teaching film, to obtain better learning or amusement effects. Further, the present invention may compile the captured pictures through the installation of a compiling module, and is applied to a teaching film in which film pictures may be converted into notes, allowing the user to learn easily. In conclusion, the audio/video interaction system not only allows the viewing of a film, but also generates amusement effects and learning interaction through an interaction process, which allows audio/video service providers to provide attractive films and makes enormous contribution to the audio/video service providers.

The foregoing descriptions of the detailed embodiments are illustrated to disclose the features and functions of the present invention but are not restrictive of the scope of the present invention. It should be understood to those in the art that all modifications and variations according to the spirit and principle in the disclosure of the present invention should fall within the scope of the appended claims.

What is claimed is:

1. An audio/video interaction system comprising:
a capturing module for capturing input behaviors performed by a user on an audio/video file being played, so as to generate behavior information;
a behavior database for storing predetermined behavior patterns and the behavior information captured by the capturing module;
a behavior analyzing module for analyzing the behavior information to thereby generate statistical information and store the statistical information thus generated; and
an interaction module for comparing the behavior information and the predetermined behavior patterns to thereby provide corresponding feedback information.

2. The audio/video interaction system of claim 1, further comprising a playing module for outputting the audio/video file, wherein the capturing module captures the input behaviors performed by the user on the audio/video file when the playing module outputs the audio/video file.

3. The audio/video interaction system of claim 1, wherein the behavior information comprises selection information, circle information, click information and picture-capturing information generated by the user through the input behaviors of selecting, circling, clicking or frame-capturing.

4. The audio/video interaction system of claim 3, wherein the behavior information further comprises user data, audio/video file data and audio/video file output time data.

5. The audio/video interaction system of claim 3, further comprising a compiling module for compiling pictures, allowing the user to compile the captured pictures.

6. The audio/video interaction system of claim 3, wherein the capturing module captures coordinate location where the user's input behavior is performed on the audio/video files or the captured picture information of the audio/video file, and generates corresponding behavior information.

7. The audio/video interaction system of claim 1, wherein the feedback information comprises corresponding information obtained from comparison of the captured behavior information and the predetermined behavior patterns after the user has stopped performing input behaviors on the audio/video file or displaying information has been fed back to the user according to comparison of the captured behavior information and the predetermined behavior patterns in real time.

8. The audio/video interaction system of claim 1, wherein the interaction module prompts corresponding displaying information according to the statistical information while the audio/video file is playing.

9. The audio/video interaction system of claim 1, wherein the behavior analyzing module stores analytic results into the behavior database to thereby generate, after a predetermined time period, the statistical information based on the behavior information and/or the analytic results stored in the behavior database.

10. An audio/video interaction method, comprising the steps of:
(1) capturing input behaviors performed by a user while an audio/video file is being output, so as to generate behavior information; and
(2) comparing the behavior information with predetermined behavior patterns to obtain corresponding feedback information, followed by analyzing the behavior information to generate corresponding statistical data, thereby providing the feedback information when the audio/video file is output or providing the statistical data when the outputting of the audio/video file is discontinued.

11. The audio/video interaction method of claim 10, wherein the behavior information comprises selection information, circle information, click information and picture-capturing information generated by the user through the input behaviors of selecting, circling, clicking or frame-capturing.

12. The audio/video interaction method of claim 10, wherein step (1) comprises the sub-step of capturing an input coordinate position of the audio/video file the input behaviors are performed on by the user or capturing picture information, so as to take the captured input coordinate position or the captured picture information as one of parameters of the behavior information.

13. The audio/video interaction method of claim 10 further comprising providing a compiling interface when the input behavior is picture-capturing, so as for the user to post-produce and compile the captured pictures.
